(19) United States
(12) Patent Application Publication
(10) Pub. No.: US 2016/0247414 A1
(43) Pub. Date: Aug. 25, 2016

(54) PRO-SOCIAL, EDUCATIONAL GAME SYSTEM

(71) Applicant: Sam Houston State University, Huntsville, TX (US)

(72) Inventors: Hannah R. Gerber, Huntsville, TX (US); Melissa Lynn Ashworth, Kingwood, TX (US); Christiaan Stephanus Cronje, Spring, TX (US); Luis Eduardo Gaitan Landaverde, Houston, TX (US)

(21) Appl. No.: 15/050,354

(22) Filed: Feb. 22, 2016

Related U.S. Application Data
(60) Provisional application No. 62/119,214, filed on Feb. 22, 2015.

(51) Int. Cl. G09B 19/00; A63F 13/92; A63F 13/80; G09B 5/02

(52) U.S. Cl. CPC G09B 19/00; G09B 5/02; A63F 13/92; A63F 13/80

(57) ABSTRACT

A method may be directed towards promoting one or more socially beneficial objectives. The social objective may be, in one embodiment, safe management of trash in a location in one or more developing countries. The method may include providing a mobile game to a player. The game may educate the players of the game with regard to the objectives. The method may include providing a plurality of challenges to the player. The challenges may be related to one or more local initiatives. The challenges may include queries related to at least one of the local initiatives. In some embodiments, the local initiative includes refuse disposal. The method may include making donations to an organization based on actions or outcomes in the game. The organization may use the donations to further the local initiative.

### PRIORITY CLAIM

This application claims the benefit of U.S. Provisional Application Ser. Nos. 62/119,214 entitled “PRO-SOCIAL, EDUCATIONAL GAME SYSTEM” filed Feb. 22, 2015, which is incorporated herein by reference in its entirety.

### BACKGROUND

1. Technical Field

Embodiments described herein relate to systems and methods for using game-based learning to teach specific skills and/or lessons. More particularly, some embodiments disclosed herein relate to systems and/or methods of using gamification in applications that promote a positive social impact.

2. Description of the Related Art

Gamification and game-based learning is a growing trend in education and industry, emerging from the videogame industry. Gamification is the use of game thinking and game mechanics to engage audiences to solve problems. It has been used, for example, in business and industry to increase productivity among workers, increase revenue in selling products, and to gain new clients and/or retain existing clients.

Many developing nations lack both education and infrastructure to deal with many societal and environmental problems. Such problems include, for example, the overwhelming trash problem in some countries. Often trash ends up in the streets, burning and/or being scavenged by locals leading to hygiene and health issues. Egypt and India have, for example, been struck by this problem in recent years. Part of the problem has been the reliance on foreign companies to manage the trash clean-up, rather than local initiatives.

### SUMMARY

In some embodiments, a method is directed towards promoting one or more socially beneficial objectives using games. The social objective may be, in one embodiment, safe disposal of trash in a location in one or more developing countries. The method may include providing a mobile game to a player. The game may be provided by way of a mobile game platform that includes a mobile app on one or more mobile devices. The game may educate the players of the game with regard to the objective. The method may include providing a plurality of challenges to the player. The challenges may be related to one or more local initiatives. The challenges may include queries related to at least one of the local initiatives. In some embodiments, the local initiative includes refuse disposal. The method may include making donations to an organization based on actions or outcomes in the game. The organization may use the donations to further the local initiative.

### BRIEF DESCRIPTION OF THE DRAWINGS

The following detailed description makes reference to the accompanying drawings, which are now briefly described.

FIG. 1 illustrates one embodiment of providing a mobile game to players to effect or promote a pro-social objective.

FIG. 2 illustrates one embodiment of a system including a pro-social game server and mobile devices.

FIG. 3 depicts a network diagram of an embodiment of a wide area network that may be suitable for implementing various embodiments.

FIG. 4 depicts a block diagram of one embodiment of an exemplary computer system.

Specific embodiments are shown by way of example in the drawings and will be described herein in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112 paragraph (f), interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

In some embodiments, a method may be directed towards promoting one or more socially beneficial objectives. The social objective may be, in one embodiment, safe management of trash in a location in one or more developing countries. The method may include providing a mobile game to a player. The game may be provided by way of a mobile game platform that includes a mobile app on one or more mobile devices. The game may educate the players of the game with regard to the objectives. The method may include providing a plurality of challenges to the player. The challenges may be related to one or more local initiatives. At least some of the challenges may include queries related to at least one of the local initiatives. The method may include making donations to an organization based on actions or outcomes in the game. The organization may use the donations to further the local initiative.

In some embodiments, a prosocial gamified application assists in helping educate and draw attention to a social problem. The problem may be, in various embodiments, a global problem. In one embodiment, the problem is what to do with trash/refuse in developing nations, and the game system effects or promotes safe and effective handling and disposition of trash.

In some embodiments, a mobile game educates youth about recycling. The game instructs youth on multiple methods that can be used to recycle. The system provides funding for developing infrastructure for sustainability of newly developed recycling programs that are created by youths' experience with the game.

In some embodiments, a system provides game play to educate the public and create a problem-solving climate for dealing with the trash clean up. The games may promote putting the issue of trash clean-up back in local companies' hands, thus providing local income to residents, and supporting the development of local infrastructure, thereby working towards sustainably growing local economies.

In some embodiments, an application may be used to foster public education and a problem solving climate. In some embodiments, an application may be function in combination one or more software platforms (e.g., Android compatible phones, Apple compatible phones, etc.). In some embodiments, an application may allow players to virtually travel to developing nations across the globe. The main screen may put the player in a road. As trash rains down, the players may move up the road at a set speed and be required to sort trash on the fly.

In some embodiments, the challenge may be presented through the speed at which players travel down the road, and the location to which the players throw the trash (e.g., open can, closed can, recyclable etc.). This may change quickly thus challenging the player to throw away to the proper location. If players miss the can, or throw into the wrong bin, trash may begin to pile in the street. If too much trash piles up, players may get a “Game Over” notification.

In some embodiments, mini-challenges may be presented to players as the player throws trash away. In some embodiments, as a player levels up, each challenge may increase (e.g., such as the speed at which they must sort the trash etc.). As the player levels up, questions and facts may be presented to the player about a particular issue (e.g., global trash problem, hygiene related issues, etc.). These facts, questions, and any game instructions may be translated using known and future translation software (e.g., Sovee Language Translation, a cloud-based language translation system (www.sovee.com)), which may translate 50 languages during game play, thus enabling the app to be used by many different people who speak languages other than English.

In some embodiments, as players level up, a donation (e.g., money) may be made every time the player levels up to an initiative (e.g., a local initiative that will work on both educating and employing locals for immediate trash clean-up of the streets, regular trash pick-up service, and/or systematic trash recovery (including recycling programs, etc.) Initiatives may include non-profits (e.g., in Egypt including educational groups and/or environmental groups, American International Middle East (educational group), the environmental branch of OTA in the Sinai). In certain embodiments, monies from leveling up may come from corporate sponsorships (e.g., TOVA Mobile through AT&T and Google). Monies may go directly to local initiatives (e.g., starting in Egypt, and branching into India, and then to other developing nations as the project develops and becomes more sustainable).

In some embodiments, an application may come preloaded on different formats or platforms (e.g., Teleios Education and TOVA Mobile, educational software development and mobile hardware companies, having the app pre-loaded on the TOVA tablets during the manufacturing process).

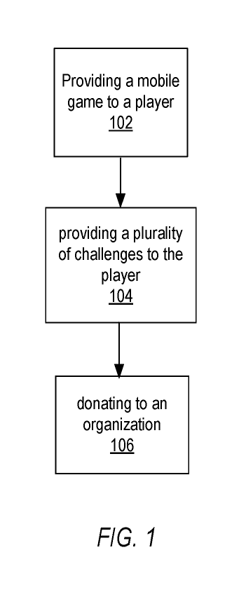

FIG. 1 illustrates one embodiment of providing a mobile game to players to effect or promote a pro-social objective. At 102, a mobile game is provided to a player. The game may be served to numerous players, each have a mobile app installed on a mobile device, such as an Android smart phone.

At 104, challenges are provided to the players. In some cases, the challenges relate to trash management, such as those described above.

At 106, a donation is made to one or more organizations. The donation may be based on an outcome in the game by one or more of the players. For example, a donation may be based on one or more players achieving a new level in the game. In some cases, a donation of money is made to promote a local initiative to clean up trash. The donation may be used to employ a local person to perform services to promote the objective (e.g., perform trash disposal services or recycling services), to educate a local person on the objective, or provide physical or infrastructure resources (e.g., build waste disposal facilities, acquire trucks, etc.) The objective may be carried out using the physical or infrastructure resources (for example, a recycling system, a trash disposal system).

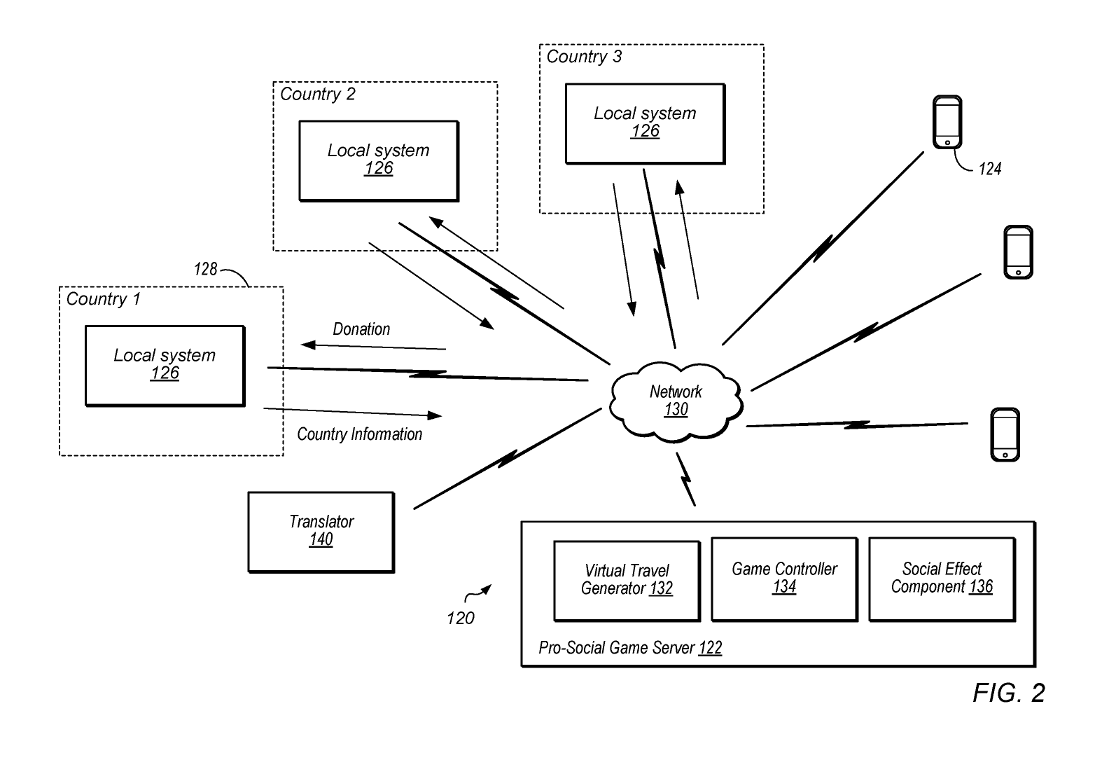

FIG. 2 illustrates one embodiment of a system including a pro-social game system. System 120 includes pro-social game server 122, mobile devices 124, systems 126, and network 130. Local systems 126 may be located in in various countries 128. In some embodiments, countries 128 are developing countries. Mobile devices 124 may be, for example, smart phones. Each smart phone may have a mobile app installed to enable play of the game.

In one embodiment, trash disposal is promoted or effected through a game played by users on mobile devices 124, served from pro-social game server 122. Pro-social game server 122 may, in some embodiments, be implemented by way of cloud computing services. In this example, pro-social game server 122 is implemented via components including virtual travel generator 132, game controller 134, and social effect component 136. Virtual travel generator 132 may receive information about countries 132 from systems 126 and/or from other sources. Virtual Travel Generator 132 may determine collect and organize facts about trash management, recycling, or other topics in various countries. Virtual travel generator 132 may collect facts and generate questions, instructions, or other information to be served to players of the game, including, for example, a road for each user to travel on to play the game. Game controller 134 may serve the game to various users on mobile devices 124.

Based on what happens in each game, social effect component 136 may generate a socially positive effect. For example, based on a particular score in a game, the system may generate a contribution to a fund for local initiatives in one or more countries. In some cases, the effect corresponds to the country or locality in which the user was playing virtually. For example, if the user was playing a game in which trash was virtually removed in Egypt, a donation may be made to a local initiative in Egypt. In certain embodiments, the social effect component may be coupled via a network to one or more resources (e.g., physical resources such as a recycling system or waste disposal system, or an educational system) for carrying out the effect.

Translator 140 may process information from different languages for use in the conduct of the games. Translator 140 may be used to process information to be used to generate the game and/or to serve information to users. In some embodiments, translation is provided by way of a cloud-based translation system.

In FIG. 2, only three countries and three mobile devices are shown for illustrative purposes. A system may, however, generate game information and promote pro-social outcomes in any number of countries played by any number of users.

In certain embodiments, one or more process steps described herein may be performed over a network such as a wide area network. For example, process 100, shown in FIG. 1 may have one or more steps performed over a network (e.g., a wide area network).

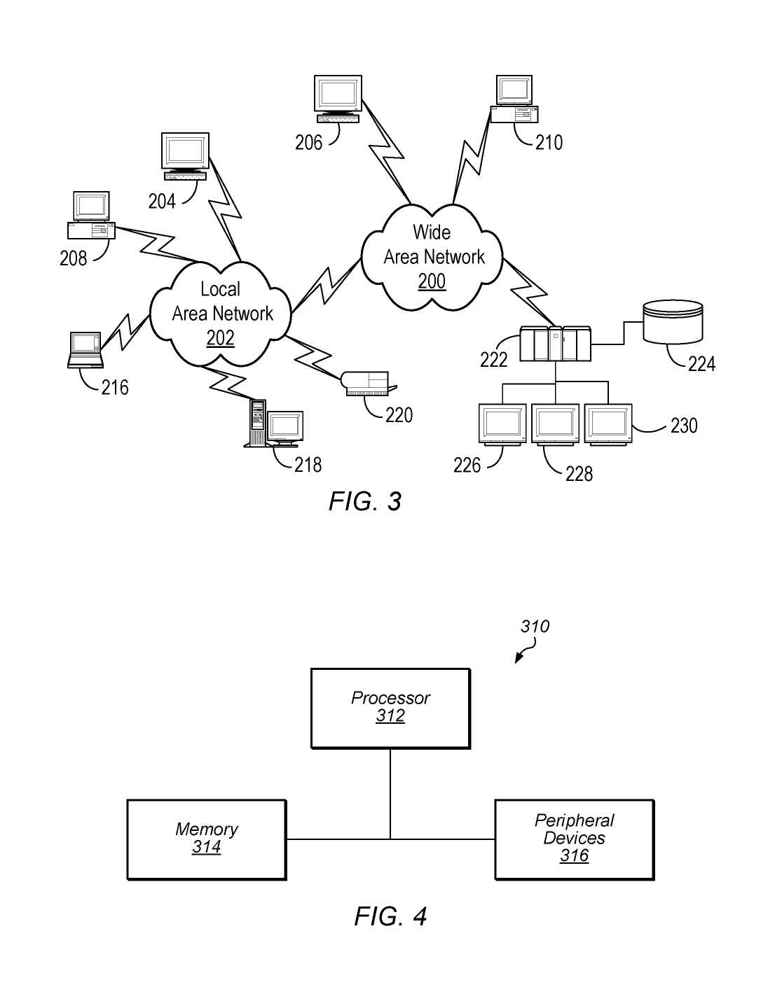

FIG. 3 illustrates a wide area network (“WAN”) according to one embodiment. WAN 200 may be a network that spans a relatively large geographical area. The Internet is an example of a WAN. WAN 200 may typically include a plurality of computer systems that may be interconnected through one or more networks. Although one particular configuration is shown in FIG. 3, WAN 200 may include a variety of heterogeneous computer systems and networks that may be interconnected in a variety of ways and that may run a variety of software applications.

One or more local area networks (“LANs”) 202 may be coupled to WAN 200. LAN 202 may be a network that spans a relatively small area. Typically, LAN 202 may be confined to a single building or group of buildings. Each node (i.e., individual computer system or device) on LAN 202 may have its own CPU with which it may execute programs, and each node may also be able to access data and devices anywhere on LAN 202. LAN 202, thus, may allow many users to share devices (e.g., printers) and data stored on file servers. LAN 202 may be characterized by a variety of types of topology (i.e., the geometric arrangement of devices on the network), of protocols (i.e., the rules and encoding specifications for sending data and whether the network uses a peer-to-peer or client/server architecture), and of media (e.g., twisted-pair wire, coaxial cables, fiber optic cables, and/or radio waves).

Each LAN 202 may include a plurality of interconnected computer systems and optionally one or more other devices such as one or more workstations 204, one or more personal computers 208, one or more laptop or notebook computer systems 216, one or more server computer systems 218, and one or more network printers 220. As illustrated in FIG. 2, an example of LAN 202 may include at least one of each of computer systems 204, 208, 216, and 218, and at least one printer 220. LAN 202 may be coupled to other computer systems and/or other devices and/or other LANs 202 through WAN 200.

One or more mainframe computer systems 522 may be coupled to WAN 200. As shown, mainframe 522 may be coupled to a storage device or file server 224 and mainframe terminals 226, 228, and 230. Mainframe terminals 226, 228, and 230 may access data stored in the storage device or file server 224 coupled to or included in mainframe computer system 522.

WAN 200 may also include computer systems connected to WAN 200 individually and not through LAN 202 such as, for purposes of example, workstation 206 and personal computer 210. For example, WAN 200 may include computer systems that may be geographically remote and connected to each other through the Internet.

In certain embodiments, one or more process steps described herein may be performed by one or more processors (e.g., a computer processor) executing instructions stored on a non-transitory computer-readable medium. For example, process 100, shown in FIG. 1 may have one or more steps performed by one or more processors executing instructions stored as program instructions in a computer readable storage medium (e.g., a non-transitory computer readable storage medium).

FIG. 3 depicts a block diagram of one embodiment of exemplary computer system 310. Exemplary computer system 310 may be used to implement one or more embodiments described herein. In some embodiments, computer system 310 is operable by a user to implement one or more embodiments described herein such as process 100, shown in FIG. 1. In the embodiment of FIG. 3, computer system 310 includes processor 312, memory 314, and various peripheral devices 316. Processor 312 is coupled to memory 314 and peripheral devices 316. Processor 312 is configured to execute instructions, including the instructions for process 100, which may be in software. In various embodiments, processor 312 may implement any desired instruction set (e.g. Intel Architecture-32 (IA-32, also known as ×86), IA-32 with 64 bit extensions, ×86-64, PowerPC, Sparc, MIPS, ARM, IA-64, etc.). In some embodiments, computer system 310 may include more than one processor. Moreover, processor 312 may include one or more processors or one or more processor cores.

Processor 312 may be coupled to memory 314 and peripheral devices 316 in any desired fashion. For example, in some embodiments, processor 312 may be coupled to memory 314 and/or peripheral devices 316 via various interconnect. Alternatively or in addition, one or more bridge chips may be used to coupled processor 312, memory 314, and peripheral devices 316.

Memory 314 may comprise any type of memory system. For example, memory 314 may comprise DRAM, and more particularly double data rate (DDR) SDRAM, RDRAM, etc. A memory controller may be included to interface to memory 314, and/or processor 312 may include a memory controller. Memory 314 may store the instructions to be executed by processor 312 during use, data to be operated upon by the processor during use, etc.

Peripheral devices 316 may represent any sort of hardware devices that may be included in computer system 310 or coupled thereto (e.g. storage devices, optionally including computer accessible storage medium 400, shown in FIG. 4, other input/output (I/O) devices such as video hardware, audio hardware, user interface devices, networking hardware, etc.).

Computer systems may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method, comprising:
providing, by a game system, a mobile game to a player;
providing, by the game system, a plurality of challenges to the player using the mobile game platform; and
donating to at least one organization based at least in part on actions or outcomes in the game, wherein the organization employs the donation to further at least one local initiative.

2. The method of claim 1, wherein the game is served to players by a mobile game platform comprising a mobile application installed on one or more mobile devices.

3. The method of claim 1, wherein at least some of the plurality of challenges comprises queries related to the at least one local initiative.

4. The method of claim 1, wherein at least some of the plurality of challenges are related to the at least one local initiative.

5. The method of claim 1, wherein the game comprises educational objectives for the players.

6. The method of claim 1, wherein the challenges comprise trash disposal in one or more developing countries.

7. The method of claim 1, wherein the at least one local initiative comprises recycling.

8. The method of claim 1, further comprising disposing of trash based at least in part on actions or outcomes in the game.

9. The method of claim 1, further comprising recycling materials based at least in part on actions or outcomes in the game.

10. A game system, comprising:
a virtual travel generator configured to generate virtual travel for one or more players;
a game controller configured to serve a game to one or more mobile users over a network, wherein the game comprises one or more challenges; and
a social effect component configured to make one or more contributions an organization based at least in part on actions or outcomes in the game.

11. The game system of claim 10, further comprising a mobile application installed on one or more mobile devices, wherein the mobile application is configured to serve the game to a user operating the mobile device.

12. The game system of claim 10, further comprising a translator configured to translate at least one fact, question, and or instruction of the game.

13. The game system of claim 10, wherein the contribution comprises a donation to an organization for a local initiative.

14. The game system of claim 10, wherein the game comprises performing trash disposal in one or more developing countries.

15. The game system of claim 10, wherein the game comprises performing recycling in on or more developing countries.

16. A non-transitory computer readable storage medium including program instructions that, when executed by one or more processors of a computer system, cause the one or more processors to perform a method comprising:
providing, by a game system implemented on one or more computers, a mobile game to a player;
providing a plurality of challenges to the player on the mobile game; and
donating to at least one organization based at least in part on actions or outcomes in the game, wherein the organization employs the donation to further at least one local initiative.

17. The computer readable storage medium of claim 16, wherein the game is served by a mobile game platform comprising a mobile application installed on one or more mobile devices.

18. The computer readable storage medium of claim 16, wherein at least some of the plurality of challenges comprises queries related to the at least one local initiative.

19. The computer readable storage medium of claim 16, wherein at least some of the plurality of challenges are related to the at least one local initiative.

20. The computer readable storage medium of claim 16, wherein the at least one local initiative comprises refuse disposal.
